(19) United States
(12) Patent Application Publication
(10) Pub. No.: US 2008/0083286 A1
(43) Pub. Date: Apr. 10, 2008

(54) Stress indicating materials

(76) Inventors: Thomas Danowski, Schaumburg, IL (US); Thomas Daly, Arlington Heights, IL (US)

Correspondence Address: Clifford Kraft, 320 Robin Hill Dr., Naperville, IL, 60540, US

(21) Appl. No.: 11/903,744

(22) Filed: Sep. 24, 2007

Related U.S. Application Data
(60) Provisional application No. 60/850,248, filed on Oct. 5, 2006.

(51) Int. Cl. G01L 1/26

(52) U.S. Cl. 73/774; 73/768; 73/776

(57) ABSTRACT

A system that uses capsules or micro-capsules containing a dye or indicator embedded in a polymer matrix to indicate or measure the degradation of structural materials. The capsules can contain an agent that will be transparent or not detected when the capsule is intact. When the capsule is ruptured, the agent will be either visible to the human eye or measurable by other detection methods. The indicator can either activate upon release or be already activated but not readily visible or detectable in the capsule. An activator compound also can be distributed in the bulk material matrix that activates the indicator upon release. For totally opaque materials like concrete or metal, a surface coating or applied tape containing the capsules can be used.

This application is related to, and claims priority from, U.S. Provisional Patent Application No. 60/850,248 filed on Oct. 5, 2006. Application No. 60/850,248 is hereby incorporated by reference.

### BACKGROUND

1. Field of the Invention

The present invention relates generally to the field of stress deformation and more particularly to a way of indicating and measuring degradation due to stress-caused deformation.

2. Description of the Problem Solved by the Invention Currently, there exists technology that enables the self healing of polymeric materials that experience fatigue and stress, and therefore are degraded by stress fractures. White in U.S. Pat. No. 6,858,659 teaches such a self-healing polymer. U.S. Pat. No. 6,858,659 is hereby incorporated by reference. These hairline fractures that are typical in any material that is placed under repetitive stress degrade the structural integrity of the material and can go unnoticed until they result in a catastrophic failure of the material. Due to the lack of obvious signs of wear and the degraded condition of the material, catastrophic failures can eventually result. A notable case of this is Aloha Airlines Flight 243. On Apr. 28, 1988 Aloha Airlines Flight 243, an inter-island flight from Hilo Airport to Honolulu International Airport carrying 89 passengers and 6 crew members, experienced rapid decompression when an 18 foot section of the fuselage roof and sides were torn from the airplane. One flight attendant was forced out of the airplane from the pressure difference and is presumed dead. The United States National Transportation Safety Board determined that the cause of the fuselage failure was metal fatigue, a repetitive stress phenomenon. This condition leaves essentially no visible signs of damage. Current technology to check for hairline cracks and other signs of damage utilizes microscopes and ultrasound equipment. This equipment is expensive and requires the material to be examined to be in a location where the equipment is present for the evaluation to take place.

It would be advantageous to have a low cost way, easy to use method of either indicating or measuring the amount of degradation, if any, that a material has experienced from the repetitive stresses.

### SUMMARY OF THE INVENTION

The present invention relates to the use of capsules or micro-capsules containing a dye or indicator embedded in a polymer matrix to measure or indicate the degradation of structural materials. The capsules can contain an indicator agent that will be transparent or not detected when the capsule is intact. When the capsule is ruptured, the agent will be either visible to the human eye, or measurable by other detection methods. The released indicator can either activate upon release, or be already activated but not readily visible or detectable while inside the capsule. An activator compound also can be distributed in the bulk material matrix that activates the indicator upon release. For totally opaque materials like concrete or metal, a surface coating or applied tape containing the capsules can be used.

### DESCRIPTION OF THE FIGURES

Attention is now directed to several illustrations that aid in understanding the present invention:

FIG. 1 shows a material with embedded micro-capsules containing an indicator.

FIG. 2 shows the material of FIG. 1 after stress deformation.

FIG. 3A shows a coating for an opaque material containing micro-capsules.

FIG. 3B shows a tape containing micro-capsules.

Several illustrations and drawings have been presented to better aid in understanding the invention. The scope of the present invention is not limited to what is shown in the figures.

### DESCRIPTION OF THE INVENTION

The present invention relates to a stress deformation indicating and/or measuring system. A system of micro-capsules can be distributed throughout the bulk matrix of a plastic or polymer material. When the material is deformed, some of the micro-capsules rupture releasing an indicator material into the bulk matrix. The capsules or micro-capsules can carry an unactivated indicator, or an indicator that is not normally detectable through the wall of the embedded capsule before it breaks. For example, the indicator can be a dye, or it could be a material that is activated upon release. Detection methods can be simply seeing the released dye by visual inspection or by using light or other techniques such as fluorescence or the detection of absorbance or radiation. The wall of the micro-capsule can be either transparent to the detection method or opaque to it.

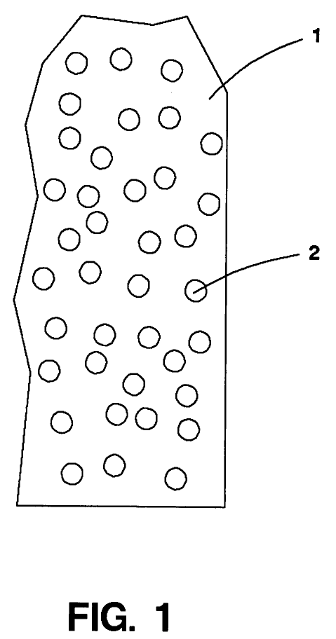

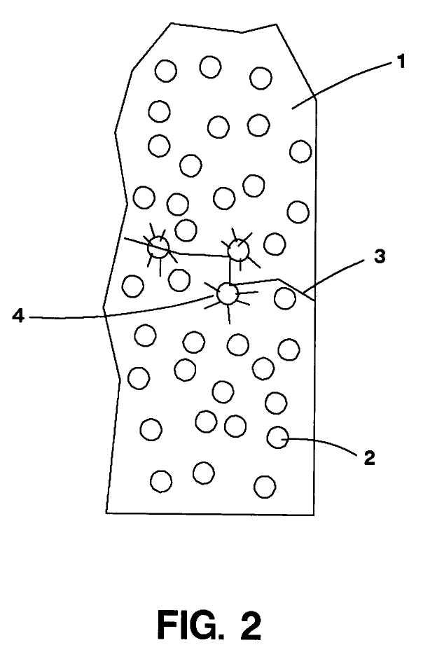

In the case where the capsule wall is transparent to the detection method such as light of a particular wavelength, the bulk material can have an activator compound dispersed in it. When the material undergoes stress deformation, some of the capsules burst releasing the indicator. The released indicator can then react with the dispersed activator and become detectable. In the case where the capsule walls are opaque to the detection method, a detector can be used to correlate the strength of a signal, such as absorbance, to the amount of stress or deformation. The simplest form of indicator is a dye that is visible to the naked eye in a transparent polymer matrix. In this case, the damaged state would be readily detectable by a visual inspection. The undamaged configuration of a system containing micro-capsules is illustrated in FIG. 1; the damaged configuration can be seen in FIG. 2.

For wavelength based detection systems, the response wavelength of the indicator can be chosen to meet various needs of the application. Many applications will benefit from an indicator that is clearly visible and obvious to the naked eye when activated and invisible when not activated. Other applications will require that the indicator be active outside the visible spectrum and hence invisible to normal visual inspection. In this case, an alternative light source may be necessary and/or a fluorescing indicator may be used. A detector that is capable of detecting the absorbance or emission of a target wavelength may also be used.

In the case of opaque bulk materials, a wavelength can be chosen that can penetrate the matrix. This may or may not require a detector outside the visible range. For particularly critical applications, an analytical method to measure the degradation via the intensity of the absorbance or emission caused by the indicator may be desirable. By developing data that corresponds with various failure modes and events, a predictive system can be developed. This can enable users to accurately judge the remaining strength of the material in question.

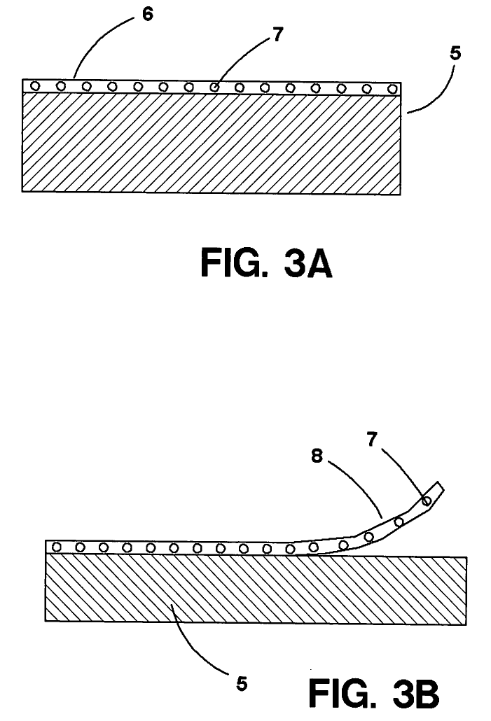

For applications where the part or item that is of concern is not a composite or plastic material, but made of another class of materials, such as metals or concrete, the invention can take the form of a coating containing micro-capsules or applied as an indicator strip or tape containing micro-capsules. FIG. 3A shows a coating; FIG. 3B shows a tape.

There are a great many applications of the present invention including essentially any application where mechanical failure is a concern. The greater the consequence of failure, the greater the benefit. The present invention can be used to limit product liability concerns of makers of critical parts. By having a tangible and analytical means to measure the degradation of a part, the maker could determine if the part had been used outside its design and warranty parameters. Further, by providing a warning mechanism, end-user negligence could mitigate the liability of the critical part manufacturer.

The invention described herein is not limited to just indicating or measuring repetitive stress degradation, simple deformation can also be indicated or measured.

The levels of stress that any given part or material is able to withstand varies widely from application to application. The invention described herein is flexible in this regard. Not only can calibration curves of the strength of signal (such as absorbance, florescence, or visual intensity) be developed, but the size of the embedded capsules, the thickness of the walls, and the material of the walls can all be varied to produce capsules that can withstand differing levels of stress prior to rupture.

Additionally, solvents or other materials that have various coefficients of expansion can be used in conjunction with the indicator. This allows the user to determine if a part has been exposed to extreme heat or cold. Again, modifying the size, material and thickness of the capsule walls, as well as collection of data to produce calibration curves, allows the methods of the present invention to be very flexible and a quantitative method of stress determination.

While the technology of the present invention is useful unto itself, the invention described herein is a very strong compliment to the self healing materials described by White in U.S. Pat. No. 6,858,689 previously discussed. White's self healing materials can lead to a false sense of safety. By using these two technologies together, a reliable method of determining when the part is close to the end of its useful life or has been exposed to stress levels that exceed safe limits can be obtained.

Several descriptions and illustrations have been presented to better aid in understanding the present invention. One skilled in the art will recognize that numerous changes and variations can be made without departing from the spirit of the invention. Each of these changes and variations is within the scope of the present invention.

We claim:

1. A system for determining stress-related deformation or degradation of a material comprising:
Embedding a plurality of micro-capsules in said material, each of said micro-capsules containing an indicator, wherein, when said material deforms, said indicator is released into said material.

2. The system of claim 1 wherein said indicator is a dye.

3. The system of claim 1 wherein said material also contains an activator.

4. The system of claim 1 wherein release of said indicator into said material causes a detection indication normally visible to a user.

5. The system of claim 1 wherein release of said indicator into said material produces not normally visible to a user.

6. The system of claim 5 wherein release of said indicator can be detected by fluorescence.

7. The system of claim 5 wherein release of said indicator can be detected by absorbance.

8. The system of claim 5 wherein said indicator is detected by a wavelength outside of the visible spectrum.

9. The system of claim 1 wherein said micro-capsules are in a coating.

10. The system of claim 1 wherein said micro-capsules are in a tape.

11. The system of claim 1 wherein said micro-capsules have walls opaque to a particular chosen detection method.

12. A method for detecting stress-related micro-cracking or deformation of a material comprising the steps of:
embedding a plurality of micro-capsules in said material, each of said micro-capsules containing an indicator;
causing a micro-capsule to release said indicator into said material when said micro-capsule is ruptured;
detecting said indicator in said material.

13. The method of claim 12 further comprising the step of calibrating a quantity of said indicator released into said material against a particular amount of degradation of said material.

14. The method of claim 12 further comprising putting an activator into said material so that when a micro-capsule ruptures, the released indicator from said micro-capsule reacts with said activator.

15. The method of claim 12 wherein said indicator is a dye.

16. A material capable of self-indicating when it has been damaged due to stress induced cracking or other deformation comprising a bulk material matrix with a plurality of embedded capsules where each of the capsules contains an indicator compound that is released into the bulk material matrix when the capsule is ruptured.

17. The material of claim 16 wherein the indicator is a dye.

18. The material of claim 16 further comprising an activator also put into the bulk material matrix so that when the indicator is released from a ruptured capsule, the activator reacts with it to make it detectable.

19. The material of claim 16 wherein the indicator can be detected using light.

20. The material of claim 16 wherein the indicator can be detected by absorbance at least one wavelength.
